(19) United States
(12) Patent Application Publication
(10) Pub. No.: US 2005/0185705 A1
(43) Pub. Date: Aug. 25, 2005

(54) Control method of xDSL modem and xDSL modem

(76) Inventors: Keiji Tanaka, Kamifukuoka-shi (JP); Toshitaka Miyaoka, Tokyo (JP); Noboru Edagawa, Kamifukuoka-shi (JP)

Correspondence Address: CHRISTIE, PARKER & HALE, LLP, PO BOX 7068, PASADENA, CA, 91109-7068, US

(21) Appl. No.: 11/061,968

(22) Filed: Feb. 16, 2005

(30) Foreign Application Priority Data
Feb. 23, 2004 (JP) 2004-046121

(51) Int. Cl. H04B 1/38

(52) U.S. Cl. 375/222

(57) ABSTRACT

According to one embodiment of the invention, a control method of an xDSL modem to transmit/receive signals to/from an outer xDSL modem through an analog transmission line such as a telephone line is provided. A line quality of the analog transmission line is measured by training. A line profile is determined as a current profile of the analog transmission line according to the results from the training. A link is established with the determined current profile. Disconnected link is recovered with a standby profile.

### CROSS REFERENCE TO RELATED APPLICATIONS

This application claims priority to Japanese Patent Application No. 2004-046121, filed Feb. 23, 2004, the entire contents of which are incorporated herein by reference.

### FIELD OF THE INVENTION

This invention relates to a control method of an xDSL modem and an xDSL modem.

### BACKGROUND OF THE INVENTION

In recent years, an xDSL modem has been widespread as a modem for data transmission in a short range, especially for enabling data transmission between a subscriber and a telephone exchange through a telephone line.

In xDSL (ADSL, VDSL, and SDSL etc.) transmission which uses an existing telephone line, a system that uses a plurality of carriers of different frequencies is employed and a bit number to be transmitted on each carrier is determined according to a line quality of the line.

VDSL transmission is explained below as an example. A signal-to-noise ratio (SNR) in an existing telephone line is measured per carrier and a transmission rate corresponding to a result obtained by subtracting any SNR margin (noise margin) from the measured SNR is set to each carrier. The SNR obtained by subtracting any SNR margin from the measured SNR becomes a reference SNR and a maximum information amount (bit number) capable of transmitting data satisfactorily with a predetermined bit error rate (BER), e.g. 10⁻⁷, at the reference SNR is assigned to each channel. The distribution of bit number loaded on each carrier within a transmission band is called a line profile.

When it is impossible to maintain the standard transmission quality, i.e. the reference SNR, because of the influence of noise, an established link is disconnected. When the link is disconnected, the training is executed again to measure a line quality, a new reference SNR suitable for a present transmission state is set up, a bit number to be loaded on each channel is determined, a line profile is determined, and a link is reestablished using the newly determined line profile.

At the same level as a measured SNR, noise durability is enhanced by increasing the SNR margin. However, since this makes a reference SNR smaller, a bit number to be loaded on each channel and therefore a transmission rate decrease. Reversely, when an SNR margin is reduced, a transmission rate is increased. Like this, an SNR margin and a transmission rate are incompatible.

As described above, a conventional xDSL modem must execute procedures identical to those performed immediately after the introduction of power supply (i.e. the procedures from the training to measure a line quality to the determination of line profile) when a link is disconnected. Thereafter, a link is reestablished with the newly determined line profile to start data transmission. The reason why it takes negligibly longtime to reestablish a link after it was disconnected is because the training step is required to recover the link as aforementioned.

A DSL modem for monitoring qualities of upstream/downstream signals and voluntarily varying a rate and a frequency band of the upstream/downstream signals is disclosed in U.S. Pat. No. 6,167,095.

Although the maximum transmission rate of the latest xDSL modem is getting faster because a usable frequency band is extended, the time required for the training is getting longer in proportion to such a faster transmission rate. This tendency becomes even more evident when the number of carriers increases. In an xDSL modem, a link is often disconnected due to the influence of ambient noise. When a link is disconnected, the training identical to the one performed when power supply was introduced must be executed again. Accordingly, the latest models of xDSL modem tend to need longer time for recovering a link compared to old ones.

Although it is undoubtedly most desirable that links are not disconnected, it is also desired to make a period of link disconnection as short as possible. When using IP phones, for instance, link disconnection over a certain period leads to disconnection of call service.

### SUMMARY OF THE INVENTION

According to one exemplary embodiment of the invention, a control method of an xDSL modem to transmit/receive signals to/from an outer xDSL modem through an analog transmission line such as a telephone line is provided. The method includes (A) training to measure a line quality of the analog transmission line, (B) determining a line profile of the analog transmission line as a current profile according to the result from the training, (C) establishing a link using the determined current profile, (D) preparing a standby profile, (D) detecting a link disconnection, and (E) recovering the link using the standby profile according to the detecting.

According to other exemplary embodiment of the invention, a control method of an xDSL modem to transmit/receive signals to/from an outer xDSL modem through an analog transmission line such as a telephone line is provided. The method includes (A) training to measure a line quality of the analog transmission line, (B) determining a line profile of the analog transmission line as a current profile according to the result from the training, (C) establishing a link using the determined current profile, (D) detecting a link disconnection, (E) detecting a frequency that caused the link disconnection, and (F) recovering the link using a line profile excluding the frequency that caused the link disconnection.

According to other exemplary embodiment of the invention, an xDSL modem to transmit/receive signals to/from an outer xDSL modem through an analog transmission line such as a telephone line is provided. The xDSL modem includes a line quality measuring apparatus to measure a line quality of the analog transmission line, a present profile determiner to determine a current profile according to the line quality measured by the line quality measuring apparatus, a standby profile determiner to determine a standby profile to be used for link recovery after a link disconnection, a link disconnection detector to detect the link disconnection, and a link rescoverer to recover the link using the standby profile according to the detection of the link disconnection.

According to other exemplary embodiment of the invention, an xDSL modem to transmit/receive signals to/from an outer xDSL modem through an analog transmission line such as a telephone line is provided. The xDSL modem includes a line quality measuring apparatus to measure a line quality of the analog transmission line, a present profile determiner to determine a current profile according to the line quality measured by the line quality measuring apparatus, a standby profile information storage to store standby information indicating a plurality of standby profiles corresponding to a plurality of combinations of a plurality of bands which divide a transmission band of the analog transmission line, a link disconnection detector to detect a link disconnection, a frequency detector to detect a frequency that caused the link disconnection, a standby profile determiner to determine one standby profile excluding the frequency which caused the link disconnection from the plurality of standby information stored in the standby profile information storage according to detected result of the frequency detector, and a link recoverer to recover a link using the determined standby profile.

According to exemplary embodiments of the invention, when a link is disconnected, the link is recovered using a standby profile without training and therefore the time required for the link recovery is greatly reduced.

### BRIEF DESCRIPTION OF THE DRAWINGS

The above and other objects, features and advantages of the present invention will be apparent from the following detailed description of exemplary embodiments of the invention in conjunction with the accompanying drawings, in which:

FIG. 1 is a schematic block diagram of an exemplary embodiment according to the invention;

FIG. 2 is a flow chart of a control operation of the embodiment;

FIG. 3 is a detailed flow chart of a standby profile preparing routine in FIG. 2;

FIG. 4 is a flow chart of a second control operation of the embodiment; and

FIG. 5 is a flow chart of a third control operation of the embodiment.

### DETAILED DESCRIPTION

Exemplary embodiments of the invention are explained below in detail with reference to the drawings.

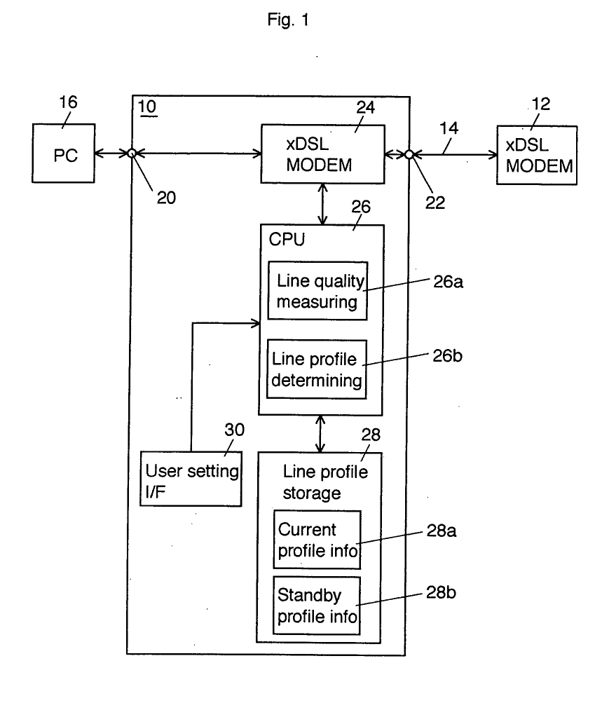

FIG. 1 shows a schematic block diagram of an exemplary embodiment according to the invention. In the embodiment, an xDSL modem 10 connects to an xDSL modem 12 which is disposed in a switching center through an existing telephone line 14. The xDSL modem 10 also connects to a user's computer 16.

The xDSL modem 10 connects to the computer 16 through a LAN terminal 20 and connects to the telephone line 14 through a telephone line connecting terminal 22. An xDSL modulator/demodulator (modem) circuit 24 is disposed between the LAN terminal 20 and the telephone line connecting terminal 22. The LAN terminal 20 includes, for example, 10/100 Base-T Ethernet®. A specific configuration of a transmission/reception circuit for Ethernet® is omitted since it is not related to exemplary embodiments of the invention.

A CPU 26 includes a line quality measuring program 26a to measure a line quality of the telephone line 14 and a line profile determining program 26b to determine a line profile to be applied for the telephone line 14. A detailed description about functions of the programs 26a and 26b is given below.

A line profile storage 28 stores a profile for current use, i.e. a current profile information 28a, and a profile to be used when a fault occurs, i.e. a standby profile information 28b. The standby profile information 28b is not necessarily to be a profile data itself but can be a parameter value to determine a standby profile.

A user can input various instructions and parameter values into the CPU 26 through a user setup interface 30. Recently, a World Wide Web (www) system has been used in general.

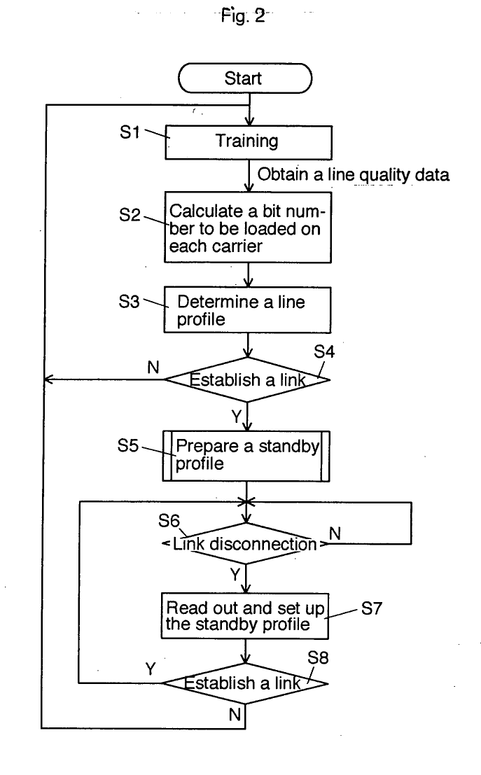

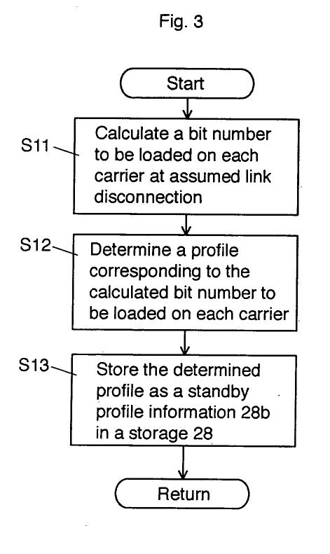

Operational characteristics of this embodiment are explained below with reference to flow charts shown in FIGS. 2 and 3. FIG. 2 shows a flow chart of a main routine of the CPU 26. FIG. 3 shows a flowchart of a standby profile preparing routine (S5).

When the power is introduced, the CPU 26 starts training to measure a line quality of the telephone line 14 connecting with the xDSL modem 12 (S1). That is, the line quality measuring program 26a measures a line state of the telephone line 14. With this operation, the CPU 26 can obtain line quality data of the telephone line 14 such as frequency characteristics of a signal-to-noise ratio (SNR).

The line profile determining program 26b in the CPU 26 calculates carriers to be used and a bit number to be loaded on each carrier by reflecting various set values such as an SNR margin in the line quality data of the telephone line 14 (S2) and determines a line profile to be applied (S3). The line profile determining program 26b stores information indicating the determined line profile in the memory storage 28 as a current profile information 28a and the CPU 26 establishes a link with the xDSL modem 12 using the line profile (S4). When it is failed to establish a link (S4), the training (S1) and the following procedures are repeated.

After a link with the xDSL modem 12 is established, the line profile determining program 26b in the CPU 26 prepares a standby profile according to a flow chart shown in FIG. 3 (S5). The standby profile is a line profile to be used immediately without training when the link with the xDSL modem 12 is disconnected.

In FIG. 3, the line profile determining program 26b calculates a bit number to be loaded on each carrier for assumed link disconnection (S11). A line profile is determined for the calculated bit number of each carrier under an SNR margin which is larger than a default SNR margin (S12). For instance, the line profile is determined with an SNR margin obtained by adding a user setup SNR margin to the default SNR margin. Information indicating the determined line profile is stored in the memory storage 28 as a standby profile information 28b (S13).

When a link disconnection is detected (S6), the CPU 26 reads out the standby profile information 28b in the memory storage 28 and tries to establish a link by switching to the standby profile indicated by the standby profile information 28b (S7). That is, the CPU 26 switches to the standby profile without the training. The standby profile information 28b is not necessarily to be the line profile information itself but can be, for example, line quality information with which a line profile is quickly calculated.

When the link is recovered with the standby profile (S8), the data communication is restarted from the step S6. When the link is not recovered (S8), the procedure after the training (S1) is repeated. When a plurality of standby profiles are prepared, link recovery should be tried using the respective standby profiles one by one and thereafter when the link is not recovered, the training (S1) and the following procedures are repeated. In this embodiment, since a link can be recovered without the training, data communication can be restarted quicker than ever.

The determining method of a standby profile and its calculating timing differ depending on a cause of assumed link disconnection. In some standby profile determining methods, a standby profile can be prepared before establishment of a link (S4).

The simplest method is to determine a line profile with an SNR margin which is larger than a default SNR margin used for the line profile (current profile) determined at the initial training and to prepare the line profile as a standby profile. FIG. 3 corresponds to this method.

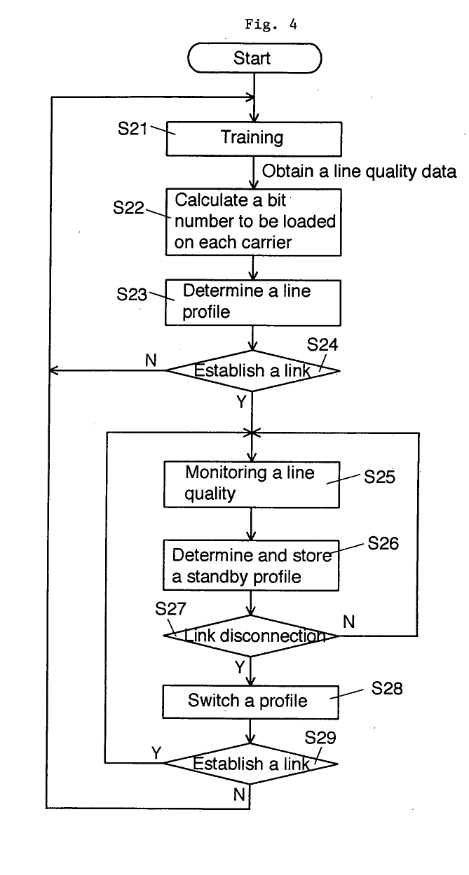

In a second method for determining a standby profile, a line profile determined according to one or more line quality measurement results immediately before a line disconnection is prepared as a standby profile. FIG. 4 shows a main flow chart of the CPU 26 corresponding to this second method.

When the power is introduced, the CPU 26 starts training of the telephone line 14 connecting to the xDSL modem 12 (S21). That is, the line quality measuring program 26a checks the line state of the telephone line 14. With this operation, the CPU 26 can obtain line quality data (e.g. frequency characteristics of SNR) of the telephone line 14.

The line profile determining program 26b in the CPU 26 calculates channels to be used and a bit number to be loaded on each channel by reflecting various set values such as an SNR margin in the line quality data of the telephone line 14 (S22) and determines a line profile to be applied (S23). The line profile determining program 26b stores information indicating the determined line profile in the memory storage 28 as a current profile information 28a and the CPU 26 establishes a link with the xDSL modem 12 using the line profile. When it is failed to establish the link (S24), the training (S21) and the following procedures are repeated.

While a link is being established (S27), the line quality measuring program 26a periodically measures a line quality (S25) and the line profile determining program 26b determines a line profile according to the measured line quality and stores information indicating the determined line profile in the memory storage 28 as a standby profile information 28b (S26). The information stored in the memory storage 28 as the standby profile information 28b may be information indicating the standby profile itself or information of a parameter value such as a measured SNR with which the standby profile can be uniquely calculated.

It is possible to store information indicating a plurality, e.g. three times, of line quality results measured immediately before the link disconnection or information based on the measured results in the memory storage 28. In that case, the standby profile information based on the plurality of line quality results is circularly updated with time. It is possible to take a user setup SNR margin into consideration when a standby profile is determined.

When a link disconnection is detected (S27), the CPU 26 reads out the standby profile information 28b in the memory storage 28 to determine a new profile from the standby profiles based on the plurality of line quality measurement results immediately before the link disconnection and tries to recover the link by switching to the new profile (S28). That is, the CPU 26 switches to the new profile without the training. When the link is recovered (S29), the data communication can be restarted from the step S25. When the link cannot be recovered with the standby profile (S29), the training (S21) and the following procedures are retried. When a plurality of standby profiles are being prepared, the link recovery should be tried using the respective standby profile one by one. When the link recovery is failed nevertheless, the training (S21) and the following procedures are retried. In this embodiment, the link is recovered without training and therefore the data communication can be restarted quickly.

In the procedure shown in FIG. 4, a new profile to be applied is for example (1) the latest profile in a plurality of standby profiles, (2) an average of a plurality of standby profiles, (3) a profile corresponding to the worst transmission quality in a plurality of standby profiles, or (4) a profile corresponding to a future line quality result estimated from a plurality of line quality results.

When the latest profile in a plurality of standby profiles is to be selected, it is sufficient for the standby profile information 28b to include information of a measured result (e.g. SNR) of only the latest profile or a line profile according to the measured result. Accordingly, a capacity of the memory storage 28 can be small and it is possible to quickly switch to a new profile according to the latest line quality. However, in this method, there is a possibility to accidentally select a line profile according to a temporary line quality which is suddenly deteriorated or improved.

On the other hand, the method to use the average of a plurality of standby profiles can prevent selecting a line profile according to a temporary line quality which is suddenly deteriorated or improved. However, this method is not capable of preventing a link disconnection when a line quality is deteriorated and therefore the possibility of link disconnection is inevitably increased.

When a profile corresponding to the worst transmission quality in a plurality of standby profiles is used, the possibility of link disconnection is greatly reduced, although it is not possible to obtain the highest speed with this method.

In a method to use a profile corresponding to a future line quality result estimated from a plurality of line quality results, for example, an SNR at a specific point in future is estimated from a plurality of temporally continuous measured results of SNR and a line profile according to the estimated SNR is used. In another method, line profiles corresponding to actually measured SNRs are calculated in advance and when a link is disconnected a line profile is recalculated according to an estimated transmission quality in future by compounding the plurality of calculated line profiles. In the former method, information such as SNRs indicating a plurality of latest transmission qualities are stored in the standby profile information 28b, and in the latter method, a plurality of line profiles corresponding to respective information such as SNRs indicating a plurality of latest transmission qualities are stored in the standby profile information 28b.

A third method for determining standby profiles is to determine standby profiles using line profiles in which a band to be used is limited. A plurality of standby profiles, each using a different band, are prepared in advance and when a link is disconnected, a current file is switched to one of the standby profiles wherein a band including a frequency that caused the link disconnection is excluded.

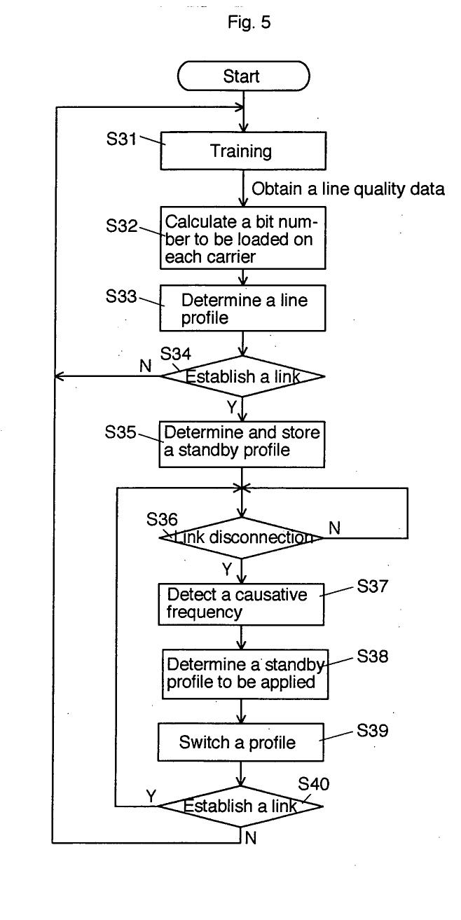

FIG. 5 shows a control flow chart of an exemplary embodiment in which standby profiles are prepared according to a combination of bands to be used.

When the power is introduced, the CPU 26 starts training of the telephone line 14 connecting with the xDSL modem 12 (S31). That is, the line quality measuring program 26a checks a line state of the telephone line 14. With this operation, the CPU 26 can obtain a line quality data (e.g. frequency characteristics of SNR etc.) of the telephone line 14.

The line profile determining program 26b in the CPU 26 calculates channels to be used and a bit number to be loaded on each channel by reflecting various set values such as an SNR margin in the line quality data of the telephone line 14 (S32) and determines a line profile to be applied (S33). The line profile determining program 26b stores information indicating the determined profile in the memory storage 28 as a current profile information 28a and the CPU 26 establishes a link with the xDSL modem 12 using this line profiling. When it is failed to establish a link (S34), the training (S31) and the following procedures are repeated.

When a link is established (S34), line profiles corresponding to combinations of bands in which one band used for the current profile is excluded are prepared and thereafter information indicating the determined respective line profiles is stored in the memory storage 28 as a standby profile information 28b.

For instance, in Plan 998, ITU-T, ANSI, and ETSI, signal frequency bands are divided into a band DS1 which is from 138 (kHz) to 3.75 (MHz), a band US1 which is from 3.75 (MHz) to 5.2 (MHz), a band DS2 which is from 5.2 (MHz) to 8.5 (MHz), and a band US2 which is from 8.5 (MHz) to 12.0 (MHz). The bands US1 and US2 are for upstream, and the bands DS1 and DS2 are for downstream. For example, when a line profile which uses all bands of the DS1, US1, DS2, and US2 is applied as a current profile, a line profile 1 which uses the bands DS1, US1, and DS2, a line profile 2 which uses the bands DS1, US1, and US2, and a line profile 3 which uses the bands DS1 and US1 are prepared as standby profiles.

When a link disconnection is detected (S36), the CPU 26 detects a frequency which caused the link disconnection (S37), determines a standby profile which does not include the frequency that caused the link disconnection from the plurality of standby profiles stored in the memory storage 28 as the standby profile information 28b (S38), and tries to recover the link by switching to the determined standby profile (S39). The time required to detect the causative frequency is much shorter than the time required for the training. Accordingly, within a quite short time a new link can be established using a line profile in which the cause of link disconnection is removed.

When the link is recovered using the standby profile (S39), the data communication can be restarted from the step S36. When the link is not recovered (S40), the training (S31) and the following procedures are repeated. When a plurality of standby files are prepared, the link recovery should be tried using the standby profiles one by one. When nevertheless the link is not recovered, the training (S31) and the following procedures are repeated. In this exemplary embodiment, since a link is recovered without the training, data communication can be restarted quickly.

In this embodiment, standby profiles can be prepared not only per band but also per carrier.

While the invention has been described with reference to the specific embodiment, it will be apparent to those skilled in the art that various changes and modifications can be made to the specific embodiment without departing from the spirit and scope of the invention as defined in the claims.

1. A control method of an xDSL modem to transmit/receive signals to/from an outer xDSL modem through an analog transmission line such as a telephone line comprising:
training to measure a line quality of the analog transmission line;
determining a line profile as a current profile of the analog transmission line according to the result from the training;
establishing a link using the determined current profile;
preparing a standby profile;
detecting a link disconnection; and
recovering the link using the standby profile according to the detecting.

2. The method of claim 1 wherein the preparing a standby profile determines the standby profile according to the line quality measured by the training and assumable predetermined causes of link disconnection.

3. The method of claim 1 wherein the preparing a standby profile comprises:
monitoring the line quality of the analog transmission line while the link is being established; and
calculating the standby profile according to the line quality obtained from the monitoring.

4. The method of claim 1 wherein the preparing a standby profile comprises:
monitoring the line quality of the analog transmission line while the link is being established; and
calculating the standby profile based on a plurality of line qualities at different time obtained through the monitoring.

5. The method of claim 4 wherein the calculating the standby profile comprises:
calculating a plurality of line profiles corresponding to respective line qualities obtained through the monitoring; and
calculating the standby profile based on the plurality of line profiles.

6. The method of claim 1 wherein the standby profile is determined by an SNR margin being larger than an SNR margin applied to the present profile.

7. A control method of an xDSL modem to transmit/receive signals to/from an outer xDSL modem through an analog transmission line such as a telephone line comprising:
training to measure a line quality of the analog transmission line;
determining a line profile as a current profile of the analog transmission line according to result from the training,
establishing a link using the determined current profile;
detecting a link disconnection;
detecting a frequency that caused the link disconnection; and
recovering the link using a line profile excluding the frequency that caused the link disconnection.

8. The method of claim 7 further comprising:
preparing line profiles corresponding to a plurality of combinations of bands to divide a transmission band of the analog transmission line; and
searching line profiles in which the frequency that caused the link disconnection is excluded from the prepared line profiles.

9. An xDSL modem to transmit/receive signals to/from an outer xDSL modem through an analog transmission line such as a telephone line comprising:
a line quality measuring apparatus to measure a line quality of the analog transmission line;
a current profile determiner to determine a current profile according to, the line quality measured by the line quality measuring apparatus;
a standby profile determiner to determine a standby profile to be applied for link recovery after a link disconnection;
a link disconnection detector to detect the link disconnection; and
a link recoverer to recover the link using the standby profile according to the detection of the link disconnection.

10. The xDSL modem of claim 9 wherein the standby profile determiner determines the standby profile according to a line quality of the analog transmission line measured by the line quality measuring apparatus after the power is introduced and assumable predetermined causes of link disconnection.

11. The xDSL modem of claim 9 wherein the standby profile determiner comprises:
a controller to make the line quality measuring apparatus measure the line quality of the analog transmission line while the link is being established; and
a calculator to calculate the standby profile from the line quality of the analog transmission line while the link is being established.

12. The xDSL modem of claim 9 wherein the standby profile determiner comprises:
a controller to make the line quality measuring apparatus measure the line quality of the analog transmission line while the link is being established; and
a calculator to calculate the standby profile from a plurality of line qualities of the analog transmission line measured at different time while the link is being established.

13. The xDSL modem of claim 9 wherein the standby profile determiner comprises:
a controller to make the line quality measuring apparatus measure the line quality of the analog transmission line at different time while the link is being established;
a first calculator to calculate line profiles corresponding to the line qualities of the analog transmission line measured at different time while the link is being established; and
a second calculators to calculate the standby profile from the plurality of line profiles by the first calculator.

14. The xDSL modem of claim 9 further comprising a memory storage to store information indicating one or more line qualities of the analog transmission line measured by the line quality measuring apparatus while the link is being established.

15. The xDSL modem of claim 9 further comprising a memory storage to store information indicating the standby profiles determined by the standby profile determiner.

16. An xDSL modem to transmit/receive signals to/from an outer xDSL modem through an analog transmission line such as a telephone line comprising:
a line quality measuring apparatus to measure a line quality of the analog transmission line;
a current profile determiner to determine a current profile according to the line quality measured by the line quality measuring apparatus;
a standby information storage to store standby information indicating a plurality of standby profiles corresponding to a plurality of combinations of bands which divide a transmission band of the analog transmission line;
a link disconnection detector to detect a link disconnection;
a frequency detector to detect a frequency which caused the link disconnection;
a standby profile determiner to determine one standby profile excluding the frequency which caused the link disconnection from the plurality of standby information stored in the standby profile information storage according to detected result of the frequency detector; and
a link recoverer to recover the link with the determined standby profile.
